(19) United States
(12) Patent Application Publication
(10) Pub. No.: US 2011/0214120 A1
(43) Pub. Date: Sep. 1, 2011

(54) INSTALLER AND METHOD OF INSTALLING PRINTER DRIVER

(75) Inventor: Takahisa Mitsuyama, Osaka (JP)

(73) Assignee: SHARP KABUSHIKI KAISHA, Osaka (JP)

(21) Appl. No.: 13/033,867

(22) Filed: Feb. 24, 2011

(30) Foreign Application Priority Data
Feb. 26, 2010 (JP) 2010-042198

(51) Int. Cl. G06F 9/445

(52) U.S. Cl. 717/176

(57) ABSTRACT

When installing an integrated type printer driver corresponding to a plurality of image processing apparatuses in an information processing apparatus, deletion of unnecessary individual printer drivers and an operation of setting various information are not required. An installer is an install program which installs the integrated type printer driver capable of executing image output from the plurality of image processing apparatuses connected to a network in the information processing apparatus. When individual printer drivers respectively controlling image output of the image processing apparatuses have been previously installed in the information processing apparatus, the installer collectively deletes the individual printer drivers of the image processing apparatuses which is able to control image output by the integrated type printer driver from the information processing apparatus at the time of installing the integrated type printer driver.

### CROSS-NOTING PARAGRAPH

This non-provisional application claims priority under 35U.S.C. §119(a) on Patent Application No. 2010-042198 filed in JAPAN on Feb. 26, 2010, the entire contents of which are hereby incorporated herein by reference.

### FIELD OF THE INVENTION

The present invention relates to an installer and a printer driver installing method, and more specifically to an installer that installs a printer driver, which is capable of executing image output from an image processing apparatus connected to a network in an information processing apparatus, and a printer driver installing method.

### BACKGROUND OF THE INVENTION

A print system which installs a printer driver in an information processing apparatus such as a PC and which connects an image processing apparatus having a print function to an information processing apparatus through a network, has been used. In such a print system, generally, image data generated by the printer driver is transmitted from the printer driver to the image processing apparatus so that an image is output (printed) on a physical medium such as recording paper by the image processing apparatus, and in that case, a printer driver in which various setting items such as output conditions in the image processing apparatus are able to be set, is required to be installed in the information processing apparatus. When installing the printer driver in the information processing apparatus, an installer which is an install program held by the information processing apparatus is executed.

In the case where the printer driver, as described above, installed in the information processing apparatus is updated by upgrading a version thereof, it is necessary to delete the printer driver which has been used until now from the information processing apparatus and newly install an updated printer driver. Then, at this time, configuration information and various setting items of the image processing apparatus are required to be set again, which becomes a burden of a user.

Furthermore, in a case where a plurality of image processing apparatuses are connected to a network so that such plurality of image processing apparatuses are able to be used arbitrarily from the information processing apparatus, a plurality of printer drivers corresponding to such plurality of image processing apparatuses are required to be installed in the information processing apparatus. In this case also, when any of the plurality of printer drivers is updated, obtaining the printer driver, deleting the corresponding printer driver which has been used until now, installing a new printer driver and resetting of configuration information and various setting items of the image processing apparatus should be performed.

FIG. 9 is a flowchart for illustrating a processing example of a conventional installer at the time of installing a printer driver.

When an installer is activated in an information processing apparatus (PC, for example) (step S41), the installer retrieves a printer to which a printer driver possessed by the installer is corresponded through a network to obtain information of the printer which is usable (step S42). At the step, as the information of the printer to which the printer driver is corresponded, information on a printer name and a setting location, an IP address and a host name are obtained. Then, the obtained information of the printer is displayed (step S43).

The installer causes a user to select any printer with a keyboard, a mouse or the like from the printer displayed on a screen (step S44). The installer, then, writes a printer driver corresponding only to the selected printer in an HDD of the information processing apparatus so as to bring a program of the printer driver into a state of being executable in the information processing apparatus. Installation of the printer driver is thereby performed (step S45). In this case, the printer driver is brought into a state of being executable, however, since being unable to possess the configuration information of the printer, unique functions possessed by the printer are not usable.

As the configuration information of the printer, there are, for example, information on peripheral apparatuses attached to the printer (staple, punch, color, etc.) and information indicating a size and a type of paper to be set in the printer, and when the configuration information of the printer is not reflected to the printer driver, a part of functions of the printer is to be limited. Therefore, the installer obtains the configuration information of the printer through the network and sets and reflects the functions usable in the printer to the printer driver (step S46).

In this manner, when the printer driver installed in the information processing apparatus is updated by upgrading the version thereof, etc., the updated printer driver should be newly installed and the configuration information and the various setting items of the image processing apparatus should be set again.

Meanwhile, an integrated type printer driver (integrated printer driver) has been provided in recent years which is capable of performing image output from a plurality of image processing apparatuses connected to a network using one printer driver. The integrated printer driver also has a convenience which a user interface is able to be switched for each image processing apparatus so that various image processing apparatuses are able to be used, and therefore, it is not necessary to install a plurality of printer drivers corresponding to individual printers.

In the case of using such an integrated printer driver, however, it is required to install the integrated printer driver after deleting (uninstalling) the printer drivers which corresponds to the individual printers that have been used until now from the information processing apparatus, and that is a troublesome operation for a user.

With respect to the printer driver installing method as described above, for example, Japanese Laid-Open Patent Publication No. 2001-236298 and Japanese Laid-Open Patent Publication No. 2001-27940 disclose a technology relating to a technique to take over setting information and configuration information.

According to Japanese Laid-Open Patent Publication No. 2001-236298, in a data processing apparatus in which a plurality of driver software which prepare data to be output to an external device are installed, conditions that are referred to when data is generated are set on each of the driver software, setting information relating to the set conditions is stored in a common storage area, and the setting information stored in the common storage area is read when using each driver software. Thereby, it is possible to prevent printing failures that occur when different printing forms are set for each printer driver, and to eliminate the trouble of setting the same printing form on the plurality of printer drivers.

Furthermore, Japanese Laid-Open Patent Publication No. 2001-27940 discloses a printing system having a printer that prints printing jobs from a host computer, in which the printing system is provided with adaptability information showing adaptability between a control program of each version and a printer driver, and judges the adaptability between a printer driver and a control program that are already installed and a printer driver and its control program that are new versions, and the printer driver and its control program that are already installed are updated to the software of a newer version when there is the adaptability between the softwares. Thereby, upgrading the version of the software is able to be performed while maintaining consistency between the softwares in the printing system in which software having functionally close relation therewith is installed.

As described above, the conventional installer is required to perform, at the time of installing a printer driver in the information processing apparatus, processing of uninstalling a printer driver of an old version beforehand when the printer driver of the old version is installed in the information processing apparatus. The uninstall processing is previously incorporated in the installer, and when a user is to install a new printer driver, the installer is able to cause the uninstall processing to be performed automatically, and moreover, it is possible that the user manually performs desired uninstallation of a printer driver.

The install and uninstall processing is required to be performed every time when a printer driver corresponding to an individual printer on a network is installed. Furthermore, in order to output to a corresponding printer after installing the printer driver, a print function which is intended by a user is required to be newly set.

The integrated printer driver as described above is useful so that an individual printer driver corresponding to each of the plurality of printers is not needed to be installed in the information processing apparatus. However, even in the case of using the integrated printer driver, in installing the integrated printer driver in the information processing apparatus, when the individual printer driver corresponding to each of the printers is installed in the information processing apparatus, the individual printer driver should be uninstalled. Additionally, even in the case where the integrated printer driver is installed, the configuration information and the various setting items of the image processing apparatus are needed to be set again, which is troublesome.

Even in the conventional techniques described in Japanese Laid-Open Patent Publication No. 2001-236298 and Japanese Laid-Open Patent Publication No. 2001-27940, when using the plurality of image processing apparatuses, the printer drivers corresponding to those are required to be installed respectively, and since this operation is not able to be reduced, the operation of the user becomes enormous, resulting in a large burden on the user.

### SUMMARY OF THE INVENTION

An object of the present invention is to provide an installer and a printer driver installing method which are simple and highly convenient by eliminating the need of a user operation of deleting unnecessary individual printer drivers and performing setting of various information to the installed integrated type printer driver when installing the integrated type printer driver which is capable of executing image output from a plurality of image processing apparatuses connected to a network from an information processing apparatus.

Another object of the present invention is to provide an installer which installs an integrated type printer driver capable of executing image output from a plurality of image processing apparatuses connected to a network in an information processing apparatus, wherein when individual printer drivers that respectively controls image output of the image processing apparatuses connected to the network have been previously installed in the information processing apparatus, the installer causes the information processing apparatus to execute a step of collectively deleting from the information processing apparatus, of the previously installed individual printer drivers, individual printer drivers of the image processing apparatuses whose image output is controlled by the integrated type printer driver, at the time of installing the integrated type printer driver.

Another object of the present invention is to provide the installer, wherein when the installer causes the information processing apparatus to execute the step of collectively deleting the printer drivers, print setting information of each printer driver to be deleted is reflected to the integrated type printer driver in a batch.

Another object of the present invention is to provide the installer, wherein when the installer causes the information processing apparatus to execute the step of collectively deleting the printer drivers, configuration information and output destination information of each image processing apparatus are taken over from the printer drivers to be deleted in a batch and reflected to the integrated type printer driver.

Another object of the present invention is to provide the installer, wherein prior to the step of collectively deleting the printer drivers, the installer causes the information processing apparatus to execute a step of retrieving a printer driver installed in the information processing apparatus and a step of judging whether or not the retrieved printer driver is a target of deletion.

Another object of the present invention is to provide a printer driver installing method for a control portion of an information processing apparatus installing an integrated type printer driver capable of executing image output from a plurality of image processing apparatuses connected to a network in the information processing apparatus, the method comprising a step of, when individual printer drivers that respectively controls image output of the image processing apparatuses connected to the network have been previously installed in the information processing apparatus, the control portion collectively deleting from the information processing apparatus, of the previously installed individual printer drivers, individual printer drivers of the image processing apparatuses whose image output is controlled by the integrated type printer driver, at the time of installing the integrated type printer driver.

### BRIEF DESCRIPTION OF THE DRAWINGS

FIG. 1 is a diagram showing a schematic configuration example of an information processing apparatus which executes an installer of the present invention;

FIG. 2 is a diagram illustrating a configuration example of the information processing apparatus shown in FIG. 1;

FIG. 3 is a diagram illustrating a configuration example of an image processing apparatus shown in FIG. 1;

FIG. 4 is a flowchart for illustrating an example of flow of installation of an integrated printer driver;

FIG. 5 is a diagram illustrating an example of a printer table prepared by an installer;

FIG. 6 is a flowchart for describing a processing example when using a printer which is not set for a printer for use as standard in the integrated printer driver;

FIG. 7 is a flowchart for describing flow of uninstall processing and install processing by taking over configuration information and print setting of a user when installing the integrated printer driver;

FIG. 8 is a diagram showing an example of a correspondence table used for retrieving individual printer drivers; and

FIG. 9 is a flowchart for describing a processing example of a conventional installer when installing a printer driver.

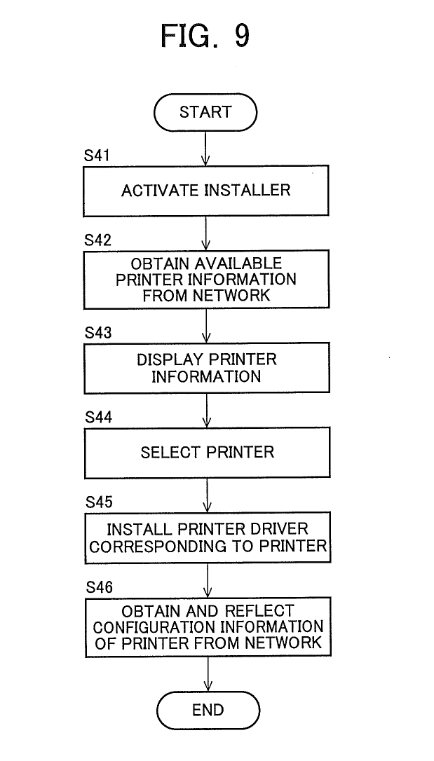

### PREFERRED EMBODIMENTS OF THE INVENTION

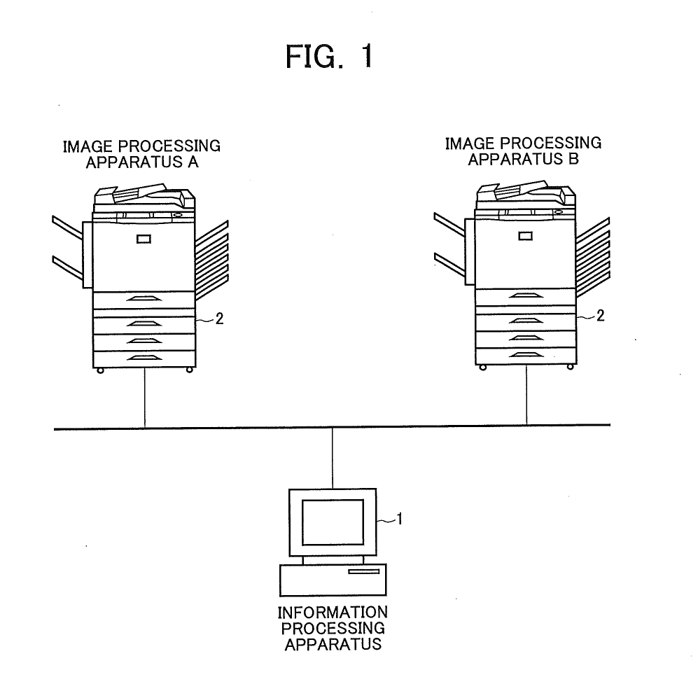

FIG. 1 is a diagram showing a schematic configuration example of an information processing apparatus which executes an installer of the present invention. An information processing apparatus 1 is connected to a plurality of image processing apparatuses 2 so as to communicate therewith through a predetermined network such as one in compliance with IEEE 802.3, for example. An image processing apparatus 2 is, for example, a printer, and a printer which has a single print function and a multi-functional peripheral (MFP) which has a plurality of functions such as a print function as well as functions of copy, facsimile are applicable thereto. Furthermore, as an example of the information processing apparatus 1, a PC (Personal Computer) is applicable.

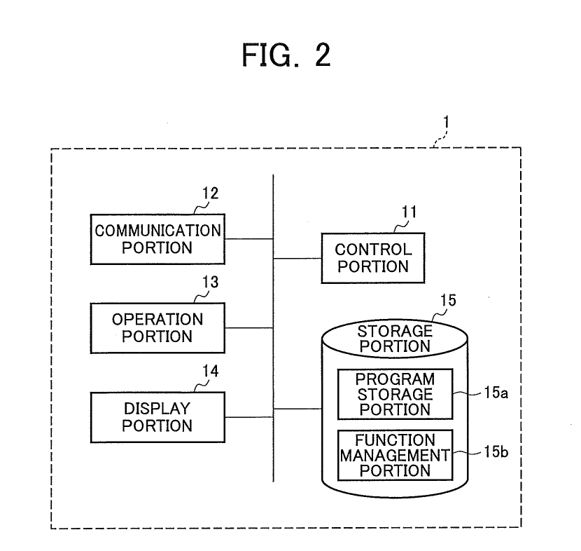

FIG. 2 is a diagram, illustrating a configuration example of the information processing apparatus shown in FIG. 1. The information processing apparatus 1 has a control portion 11, a communication portion 12, an operation portion 13, a display portion 14 and a storage portion 15.

The control portion 11 integrally controls the communication portion 12, the operation portion 13, the display portion 14 and the storage portion 15, and performs control of various software based on a program stored in the storage portion 15. For example, when installing a printer driver, a dialogue is displayed on the display portion 14, reception of input information from the operation portion 13 is performed, and processing of setting software is performed.

The communication portion 12 is connected to a network such as a LAN or internet so as to allow communication with various peripheral devices. The communication portion 12 causes an installer and a printer driver, which will be described below, to transmit output information to the image processing apparatus 2 and to obtain configuration information of the image processing apparatus 2.

The operation portion 13 is realized by using, for example, a keyboard or a mouse, and provides operation information of a user for the control portion 11. Control request of the printer driver and the installer is able to be performed for the control portion 11 with using the operation portion 13.

The display portion 14 is realized by a display medium such as a display, and provides visually to the user a content operated by a user and control information of the control portion 11.

The storage portion 15 is storage means such as an HDD (Hard Disk), a ROM (Read Only Memory), or a RAM (Random Access Memory). The storage portion 15 has a program storage portion 15a and a function management portion 15b.

The program storage portion 15a stores printer drivers corresponding to a variety of image processing apparatuses and stores an installer which installs a printer driver. The printer driver and the installer stored in the program storage portion 15a may be, for example, stored through a storage medium such as a floppy (registered trademark) disk, or alternatively, stored by receiving through a network such as internet.

Furthermore, the function management portion 15b stores function information and configuration information with respect to image output processing provided in each image processing apparatus.

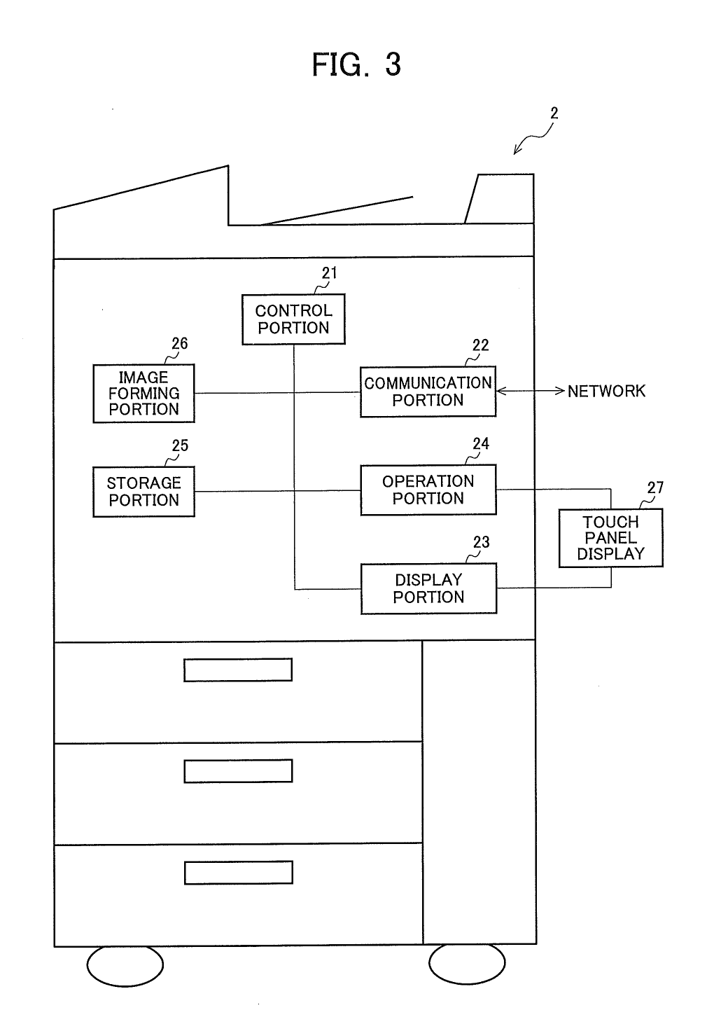

FIG. 3 is a diagram illustrating a configuration example of an image processing apparatus shown in FIG. 1. The image processing apparatus 2 has a control portion 21, a communication portion 22, an operation portion 23, a display portion 24, a storage portion 25 and an image forming portion 26.

The control portion 21 integrally controls the communication portion 22, the operation portion 23, the display portion 24, the storage portion 25 and the image forming portion 26. Moreover, the communication portion 22 is connected to a network such as a LAN so as to communicate with an external apparatus. Further, the operation portion 23 is realized by a touch panel, a button, etc., and transmits the setting or an operation request of the image processing apparatus 2 to the control portion 21.

The display portion 24 performs display of control information of the image processing apparatus 2. Moreover, the storage portion 25 stores a program, function setting, configuration information, etc., to control an operation in outputting an image by the image processing apparatus 2. Furthermore, the image processing portion 26 outputs (prints) image information on a physical medium such as recording paper in accordance with a command from the control portion 21.

Next, description of a control example of the information processing apparatus 1 and the image processing apparatus 2 will be given. As the image processing apparatus 2, a printer is taken as an example in here.

When a user performs image output processing, that is, processing to print an image on a physical medium such as recording paper by the image processing apparatus, a printer driver is required to be installed in the information processing apparatus 1. In the case of installing the printer driver in the information processing apparatus 1, the user executes an installer stored in the storage portion 15 of the information processing apparatus 1.

When the user executes the installer, the control portion 11 of the information processing apparatus 1 displays the installer which has been stored in the storage portion 15 on a display portion 14, and executes the installer corresponding to the operation of the operation portion 13 by the user. The installer obtains information of the image processing apparatus 2 from the communication portion 12 through a network, and thereby displays on the display portion 14 the information of the image processing apparatus 2 which is connected to the information processing apparatus 1.

When the user selects the image processing apparatus 2 which he/she desires to use using the operation portion 13, the control portion 11 installs the printer driver which has been stored in the storage portion 15 in accordance with an install program. At this time, the configuration information of the image processing apparatus 2 is stored in the storage portion 15.

Then, after installing the printer driver, in the case where the user wishes to output an image using the image processing apparatus 2, functions possessed by the image processing apparatus 2 are set by the operation portion 13 through the printer driver, and image output information is prepared to be transmitted from the communication portion 12 to the image processing apparatus 2. As the functions of the image processing apparatus 2, for example, 2-sided printing, punch, staple and the like are able to be set, and such information is stored in the storage portion 15.

In the image processing apparatus 2, when the control portion 21 receives the image output information of the image processing apparatus 2 from the communication portion 22, such information is held in the storage portion 25, and judgment is made on whether an image is output or holding thereof is continued or discarded. In the case of outputting an image, the control portion 21 converts the image output information in the storage portion 25 to be allowed to be output on a physical medium with the image processing apparatus 26, performs output of an image on the physical medium in the image forming portion 26, and a result thereof is displayed on the display portion 24.

In an embodiment according to the present invention, in the system as described above using the information processing apparatus 1 and the image processing apparatus 2, an installer which installs in the information processing apparatus 1 an integrated type printer driver (integrated printer driver) capable of executing image output from a plurality of image processing apparatuses 2 connected to the network is provided. In here, when individual printer drivers which respectively control image output of the image processing apparatuses 2 connected to the network have been previously installed in the information processing apparatus 1, the installer collectively deletes individual printer drivers of the image processing apparatuses 2 whose image output is able to be controlled by the integrated printer driver among the individual printer drivers which have been previously installed from the information processing apparatus 1 at the time of installing the integrated printer driver. Then, print setting information of each printer driver to be deleted is reflected to the integrated printer driver in a batch, as well as configuration information of each image processing apparatus 2 and output destination information are taken over from the printer drivers to be collectively deleted to be reflected to the integrated printer driver.

Hereinafter, description of an example of flow of installation of the integrated printer driver will be given.

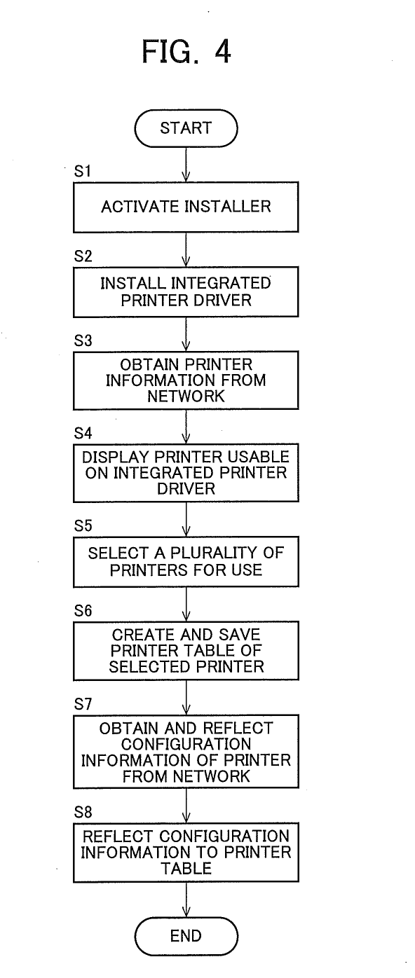

The processing example of the installation of the integrated printer driver is firstly described with reference to the flowchart of FIG. 4. Although the install processing is processing implemented in the embodiment according to the present invention, which is not representing the feature of the present invention and similar processing is also executed in a conventional integrated printer driver.

When an installer is activated in an information processing apparatus (PC, for example) (step S1), the installer writes an integrated printer driver in an HDD of the information processing apparatus, and performs installation by bringing the integrated printer driver into a state of being executable on the information processing apparatus (step S2).

Next, the installer retrieves a printer to which the integrated printer driver is corresponded through a network, obtains printer information which is able to be used with the integrated printer driver (step S3), and displays the obtained information of the printer as a list (step S4).

Next, the installer causes a user to select a plurality of printers to be used by the user from printers displayed on a screen with a keyboard, a mouse or the like (step S5). Then, the installer causes the user to select a printer for use as standard, prepares a printer table of the selected printer to be saved as the printer table of the integrated printer driver (step S6).

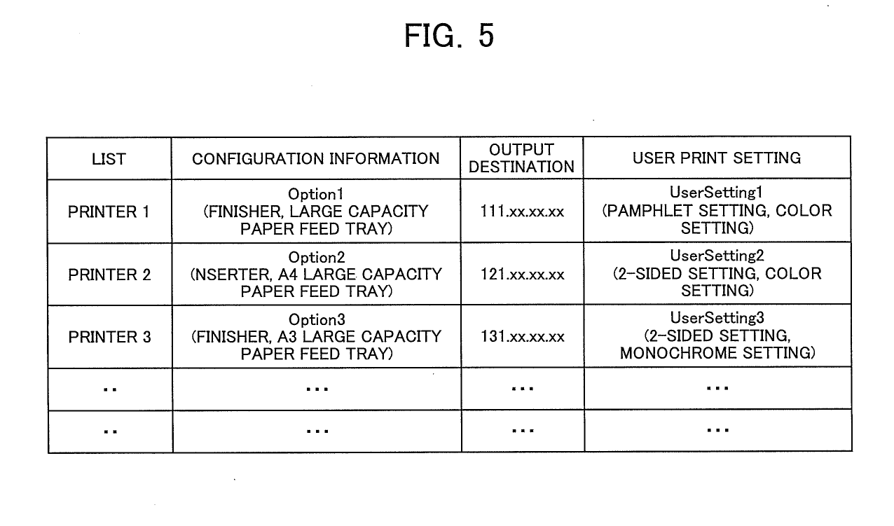

FIG. 5 shows an example of a printer table. In the printer table, configuration information of the printer, output destination information and print setting information of a user are stored. The print setting information of the user corresponds to “user print setting” in the printer table. The “user print setting” is set by a user, during installation or after installation of the printer driver, as a default setting in outputting with using a printer by the user.

Description of the flowchart of FIG. 4 will be given again. The installer, after preparing and saving the above-described printer table, subsequently obtains configuration information of the printer for use as standard through a network, and functions which are usable in the printer are set and reflected to the integrated printer driver based on the obtained configuration information (step S7). Then, the installer further reflects the obtained configuration information to the printer table (step S8).

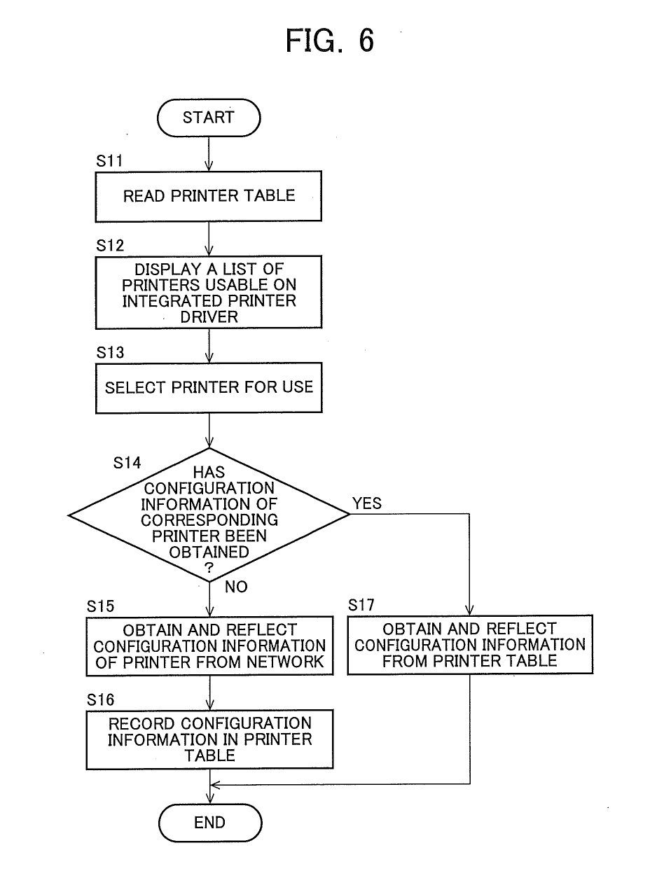

FIG. 6 is a flowchart for describing a processing example when using a printer which is not set as a printer for use as standard with the integrated printer driver. Although this processing is also implemented in the embodiment according to the present invention, similar processing is also executed in a conventional integrated printer driver.

In this case, the integrated printer driver of the information processing apparatus reads the printer table which has been stored in the storage portion (step S11), displays a list of usable printers from the printer table (step S12), and causes a user to select a printer for use (step S13).

Next, the installer determines, with respect to the selected printer, whether or not configuration information thereof has been obtained (step S14). In the case where the configuration information has not been obtained, the configuration information of the corresponding printer is obtained through the network and functions which are usable in the corresponding printer are set and reflected to the integrated printer driver based on the obtained configuration information (step S15). Further, the installer records the obtained configuration information in the printer table (step S16). On the other hand, in the case where the configuration information has been obtained with respect to the selected printer, the installer obtains the configuration information from the printer table and sets and reflects the functions which are usable in the printer to the integrated printer driver based on the configuration information (step S17).

In the case where the individual printer drivers corresponding to the respective printers have been previously installed in the information processing apparatus in which the integrated printer driver as described above is installed, the individual printer drivers are not required since the integrated printer driver serves as the individual printer drivers. Accordingly, the user is required to uninstall the individual printer drivers. Furthermore, in order to output image information to the printer following the installation of the integrated printer driver, print functions intended by the user are required to be newly set in the integrated printer driver.

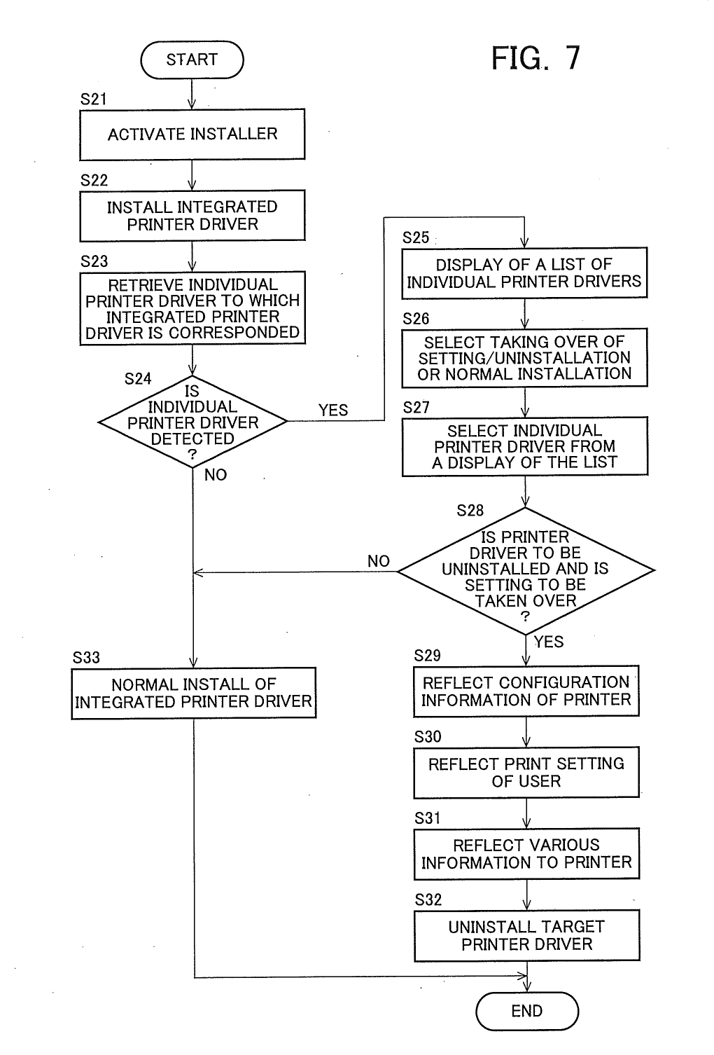

Hereinafter, description of flow of uninstall (delete) processing and install processing by taking over configuration information and print setting of a user when installing the integrated printer driver as the feature of the present invention, will be given with reference to a flowchart of FIG. 7.

At first, when an installer is activated in an information processing apparatus (PC, for example) (step S21), installation of an integrated printer driver is performed (step S22). When installation is completed, the installer retrieves whether individual printer drivers of printers to which the integrated printer driver is corresponded have been installed on the information processing apparatus (step S23), and when the individual printer drivers are detected (step S24), a list of the individual printer drivers matched with retrieval conditions are displayed (step S25).

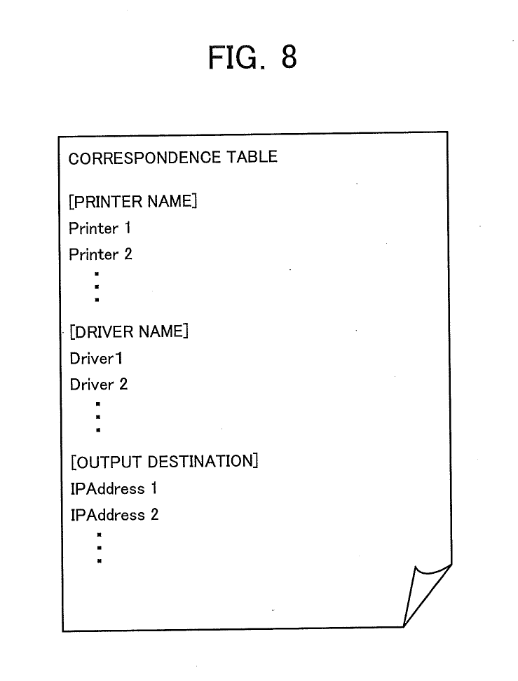

FIG. 8 is a diagram showing an example of a correspondence table used for retrieving individual printer drivers. At the time of retrieving individual printer drivers, the installer retrieves, with reference to the correspondence table as shown in FIG. 8 describing driver names, output destinations, and printer names of the individual printer drivers, a printer driver which is matched with the conditions described in the correspondence table.

Description of the flowchart of FIG. 7 will be given again. When the individual printers were not able. to be detected as a result of retrieving the individual printer drivers at the step S24, the flow shifts to the install processing of the integrated printer driver as described above (step S33).

Furthermore, in the case where individual printer drivers are detected and the individual printer drivers are displayed as a list at the above-described step S25, a user is caused to select whether the individual printer drivers are uninstalled (deleted) and output destination information, configuration information of the printer and print setting information of the user set in the individual printer drivers are to be taken over to the integrated printer driver, or normal install processing of the integrated printer driver is to be performed (step S26), and further in here, the user is caused to select the individual printer driver to which a printer used as standard by the integrated printer driver is corresponded (step S27). This means to designate a printer (default printer) which is a standard output destination of the integrated driver.

When the user selects deletion of the individual drivers and taking over of the setting (step S28—YES), the installer reflects the configuration information and the output destination information on the individual printer drivers and the print setting information of the user of the printer selected as standard to the integrated printer driver (step S29, step S30). Moreover, the configuration information, the output destination information and the print setting of the user of all the retrieved individual printer drivers are reflected to the printer table of the integrated printer driver (step S31).

Next, the installer uninstalls (deletes) all the retrieved individual printer drivers (step S32). When uninstallation of the individual printer drivers is finished, the install processing of the integrated printer driver is completed. Thereafter, when a user performs output to a target printer, the output to the printer is able to be easily performed by only calling the print setting which has been previously set in the individual printer drivers from the integrated printer driver. Then, whereby, the plurality of the individual printer drivers are able to be managed by a single printer driver by means of the integrated printer driver.

Furthermore, there will be no need for a user to set the print setting items of the individual printer drivers which are required at the time of installing the integrated printer driver by reflecting the print setting information of the individual printer drivers to be deleted collectively to the integrated type printer driver, and thus the burden of the user is able to be reduced.

In addition, taking over the configuration information of the image processing apparatus and the output destination information from the individual printer drivers to be deleted for reflection to the integrated type printer driver enables the integrated type printer to use, an optional device, etc., of the image processing apparatus without newly obtaining the configuration information from the image processing apparatus on the network when the user uses a specific image processing apparatus, and the image information is able to be output without obtaining the output destination information of the printer on the network. Moreover, the installer retrieves the printer driver installed in the information processing apparatus and judges whether or not it is a target of deletion, so that there is no need for a user to respectively judge unnecessary individual printer drivers.

According to the present invention, it is possible to provide an installer and a printer driver installing method which are simple and highly convenient by eliminating the need of a user operation of deleting unnecessary individual printer drivers and performing setting of various information to the installed integrated type printer driver when installing an integrated type printer driver which is capable of executing image output from a plurality of image processing apparatuses connected to a network in an information processing apparatus.

1. An installer which installs an integrated type printer driver capable of executing image output from a plurality of image processing apparatuses connected to a network in an information processing apparatus, wherein
when individual printer drivers that respectively controls image output of the image processing apparatuses connected to the network have been previously installed in the information processing apparatus, the installer causes the information processing apparatus to execute a step of collectively deleting from the information processing apparatus, of the previously installed individual printer drivers, individual printer drivers of the image processing apparatuses whose image output is controlled by the integrated type printer driver, at the time of installing the integrated type printer driver.

2. The installer as defined in claim 1, wherein when the installer causes the information processing apparatus to execute the step of collectively deleting the printer drivers, print setting information of each printer driver to be deleted is reflected to the integrated type printer driver in a batch.

3. The installer as defined in claim 1, wherein when the installer causes the information processing apparatus to execute the step of collectively deleting the printer drivers, configuration information and output destination information of each image processing apparatus are taken over from the printer drivers to be deleted in a batch and reflected to the integrated type printer driver.

4. The installer as defined in any one of claims 1 to 3, wherein prior to the step of collectively deleting the printer drivers, the installer causes the information processing apparatus to execute a step of retrieving a printer driver installed in the information processing apparatus and a step of judging whether or not the retrieved printer driver is a target of deletion.

5. A printer driver installing method for a control portion of an information processing apparatus installing an integrated type printer driver capable of executing image output from a plurality of image processing apparatuses connected to a network in the information processing apparatus,
the method comprising a step of,
when individual printer drivers that respectively controls image output of the image processing apparatuses connected to the network have been previously installed in the information processing apparatus, the control portion collectively deleting from the information processing apparatus, of the previously installed individual printer drivers, individual printer drivers of the image processing apparatuses whose image output is controlled by the integrated type printer driver, at the time of installing the integrated type printer driver.
